(19) United States
(12) Patent Application Publication
(10) Pub. No.: US 2013/0311540 A1
(43) Pub. Date: Nov. 21, 2013

(54) METHODS AND DEVICES FOR INITIATING A COMPLEMENTARY APPLICATION

(71) Applicants: Steven Henry Fyke, Waterloo (CA); Kevin Howard Orr, Elmira (CA)

(72) Inventors: Steven Henry Fyke, Waterloo (CA); Kevin Howard Orr, Elmira (CA)

(73) Assignee: RESEARCH IN MOTION LIMITED, Waterloo, ON (CA)

(21) Appl. No.: 13/583,256

(22) PCT Filed: May 18, 2012
(86) PCT No.: PCT/CA12/50332

§ 371 Date: Sep. 7, 2012

(51) Int. Cl. H04L 29/08

(52) U.S. Cl. CPC H04L 67/10
USPC 709/201

(57) ABSTRACT

Methods and electronic devices for initiating a complementary application are described. In one example embodiment, a method, implemented by a processor of a first electronic device is described. The method includes: establishing a connection between the first electronic device and a second electronic device; receiving a communication, wherein the communication includes textual information; determining if the textual information includes at least one key term; and if the textual information includes the at least one key term, initiating an application on the second electronic device based on the at least one key term.

### TECHNICAL FIELD

The present disclosure relates to application management and, more particularly, to methods and devices for initiating an application on a second electronic device to complement a current operational state on a first electronic device.

### BACKGROUND

Electronic devices are often equipped with various applications that perform a specific set of tasks. These applications may complement one another in order to enhance a user's experience. For example, a word processor application, such as the Microsoft® Word™ word processing software by Microsoft Corporation, may be complemented with a spreadsheet application, such as the Microsoft® Excel® spreadsheet software by Microsoft Corporation, when utilized by a user preparing a report and desiring to include charts, graphs, etc. as part of the report. In such circumstances, a user desiring to utilize multiple associated applications may have to manually locate and access the associated applications on the electronic device. This can be a cumbersome and time consuming process.

Additionally, electronic devices may be designed to be suited for specific tasks and may not have the capabilities to efficiently run certain applications or may not be equipped with such applications. For example, a tablet computer may not include telephone related applications. As such, users of some electronic devices may have a poor user experience when performing specific tasks utilizing various applications on such devices. By way of further example, a smartphone may not have sufficient screen size for ideal viewing of a spreadsheet. Due to the small screen sizes of displays on some devices, multi-tasking (i.e. utilizing multiple applications at the same time) may be difficult on some devices. Thus, on some devices, it may be difficult to utilize complementary applications.

### BRIEF DESCRIPTION OF THE DRAWINGS

Reference will now be made, by way of example, to the accompanying drawings which show example embodiments of the present application and in which:

FIG. 1 is a block diagram of a complementary system in accordance with example embodiments of the present disclosure;

FIG. 2 is a block diagram of a first electronic device in accordance with example embodiments of the present disclosure;

FIG. 3 is a block diagram of a second electronic device in accordance with example embodiments of the present disclosure;

FIG. 4 is flowchart of an example method of initiating an application in accordance with example embodiments of the present disclosure;

FIG. 5 is a flowchart of an example method of initiating an application in accordance with example embodiments of the present disclosure;

FIG. 6 is an example first electronic device and an second electronic device in accordance with example embodiments of the present disclosure; and

FIG. 7 is a flowchart of another example method of initiating an application in accordance with example embodiments of the present disclosure.

Like reference numerals are used in the drawings to denote like elements and features.

### DETAILED DESCRIPTION OF EXAMPLE EMBODIMENTS

In one example embodiment, a method, implemented by a processor of a first electronic device is described. The method includes: establishing a connection between the first electronic device and a second electronic device; receiving a communication, wherein the communication includes textual information; determining if the textual information includes at least one key term; and if the textual information includes the at least one key term, initiating an application on the second electronic device based on the at least one key term.

In another example embodiment, a first electronic device is described. The first electronic device includes a communication subsystem for communicating with a second electronic device and a memory. The first electronic device also includes a processor coupled with the memory and the communication subsystem. The processor is configured to: establish a connection between the first electronic device and a second electronic device; receive a communication, wherein the communication includes textual information; determining if the textual information includes at least one key term; and if the textual information includes the at least one key term, initiate an application on the second electronic device based on the at least one key term.

In another example embodiment, a method implemented by a processor of a second electronic device is described. The method includes: establishing a connection between the second electronic device and a first electronic device; determining if textual information within a communication received at the first electronic device includes at least one key term; and if the textual information includes the at least one key term, initiating an application based on the at least one key term.

In another example embodiment, a second electronic device is described. The second electronic device includes a communication subsystem for communicating with a first electronic device and a memory. The second electronic device also includes a processor coupled with the memory and the communication subsystem. The processor is configured to: establish a connection between the second electronic device and a first electronic device; determine if textual information within a communication received at the first electronic device includes at least one key term; and if the textual information includes the at least one key term, initiate an application based on the at least one key term.

Other example embodiments of the present disclosure will be apparent to those of ordinary skill in the art from a review of the following detailed descriptions in conjunction with the drawings.

Example embodiments of the present disclosure are not limited to any particular operating system, electronic device architecture, server architecture or computer programming language.

### Example Complementary System

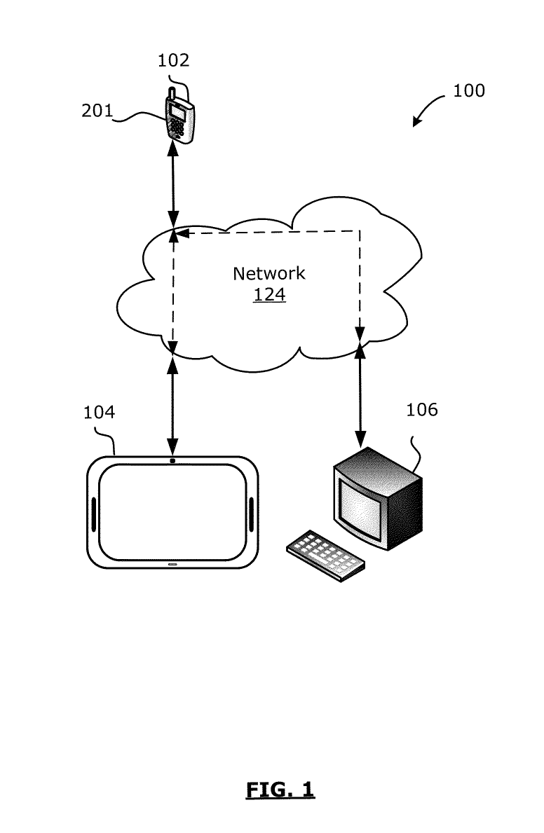

Reference will now be made to FIG. 1 which illustrates an example complementary system 100. The complementary system 100 is configured to allow a first electronic device 102 to initiate an application on a second electronic device 104 and/or a third electronic device 106. That is, the first electronic device 102 initiates an application on the second electronic device 104 and, in at least some example embodiments, the third electronic device 106 to complement the first electronic device 102. In at least some example embodiments, the complementary system 100 is also configured to allow a second electronic device 102, and/or a third electronic device 106 to initiate an application to complement the first electronic device 102. That is, the second electronic device 104, and/or the third electronic device 104 initiates the application, instead of the first electronic device 102.

In the example embodiment illustrated, the first electronic device 102 is a mobile communication device 201. More specifically, in the example embodiment illustrated, the first electronic device 102 is a smartphone. However, in other example embodiments, the first electronic device 102 may take other forms. For example, in some example embodiments, the first electronic device 102 may be a tablet computer, a wearable computer such as a watch, a notebook, notepad or a laptop computer, a desktop computer, or a television. The first electronic device 102 may take other forms apart from those specifically listed herein.

Similarly, in the example embodiment illustrated, the second electronic device 104 is illustrated as a tablet computer. However, the second electronic device 104 may take other forms. By way of example, the second electronic device 104 may be a notebook, notepad or a laptop computer, a desktop computer, a smartphone or other mobile communication device, a wearable computer such as a watch, a television, or a mobile communication device.

Similarly, while the third electronic device 106 is illustrated as a desktop computer in the example embodiment of FIG. 1, the third electronic device may also take other forms. For example, the third electronic device 106 may be a mobile communication device, a wearable computer such as a watch, a tablet computer, a notebook, notepad or a laptop computer, or another electronic device not specifically listed herein.

Example embodiments disclosed herein refer to interactions (e.g. connections and communications between) the first electronic device 102 and the second electronic device 104. It should be appreciated that the same interactions can also be between the first electronic device 102 and the third electronic device 106.

The first electronic device 102 and the second electronic device 104 are communicatively connected to one another. That is, the first electronic device 102 and the second electronic device 104 are each equipped with one or more communication subsystems which allow these electronic devices to communicate with one another. In the example embodiment of FIG. 1, the first electronic device 102 and the second electronic device 104 communicate via a network 124. Similarly, the first electronic device 102 is illustrated as communicating with the third electronic device 106 via the network 124. The network 124 may include a private network, and/or a public network, such as the Internet. For example, in some example embodiments, the first electronic device 102 and/or the second electronic device 104 are configured for Wi-Fi communications with respective network gateways.

In other example embodiments, the network 124 may not be utilized. Instead, the first electronic device 102 may connect to the second electronic device 104 and, in some example embodiments, to the third electronic device 106 via a more direct connection. For example, in some example embodiments, the first electronic device 102 may connect directly to the second electronic device 104 via a Wi-Fi connection. Similarly, in at least some example embodiments, the first electronic device 102 may connect to the second electronic device 104 via a Bluetooth™ connection. Similarly, in at least some example embodiments, the first electronic device 102 may connect to the second electronic device 104 via a near field communication (NFC) connection. Accordingly, in at least some example embodiments, the first electronic device 102 may be configured to communicate with the second electronic device 104 via a short range communication technology. That is, a short range connection may be established between the first electronic device 102 and the second electronic device 104.

In some example embodiments, after a connection is established between the first electronic device 102 and the second electronic device 104, the first electronic device 102 may initiate an application on the second electronic device 104. That is, the first electronic device 102 may initiate an application on the second electronic device 102 to complement an operating state on the first electronic device 102.

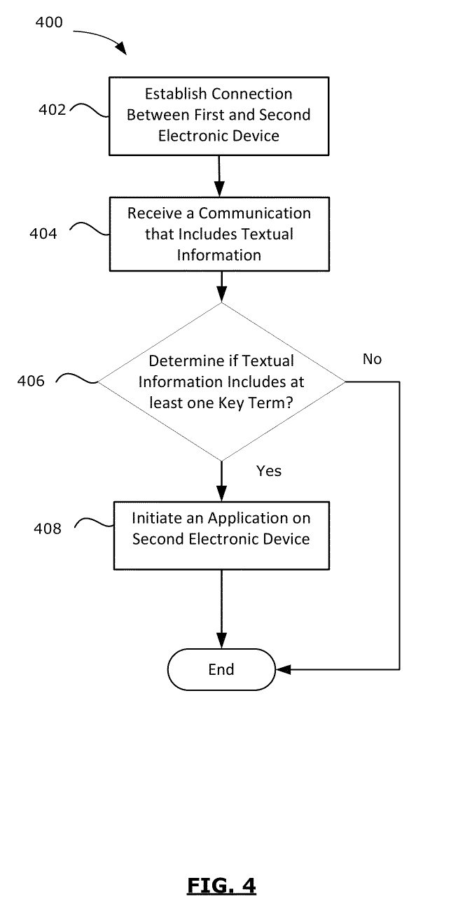

As will be discussed in greater detail below with reference to FIG. 4, in at least some example embodiments, prior to initiating the application, a communication is received at, and a determination is performed by the first electronic device 102. For example, the first electronic device 102 may receive a communication that includes textual information, such as an email message. In response to receiving the communication, the first electronic device 102 may determine if the textual information in the communication includes at least one key term. This determination may be made, for example, by comparing the text of the communication to one or more predetermined key terms, which may be stored in memory. If it determined that the textual information in the communication includes at least one key term, the first electronic device 102 may initiate an application on the second electronic device 104 based on the at least one key term included. For example, in at least some example embodiments, if the first electronic device 102 determines that the textual information includes a time-based key term (such as the term “when”), a calendar application (Such as Google Calendar™ by Google, Inc.) may be initiated on the second electronic device 104. In such example embodiments, the initiated application on the second electronic device 104 may be an application which complements a user's experience when utilizing the first electronic device 102.

In at least some example embodiments, the second electronic device 104 (and/or the third electronic device 106) may perform some of the features discussed above with reference to the first electronic device 102. For example, the first electronic device 102 may provide the textual information from the communication to the second electronic device 104 and the second electronic device may determine if the textual information in the communication received at the first electronic device 102 includes the at least one key term, and in response, initiate an application based on the at least one key term. In such example embodiments, the second electronic device 104 may monitor the first electronic device for the communication after establishing a connection with the first electronic device 102.

### Example First Electronic Device

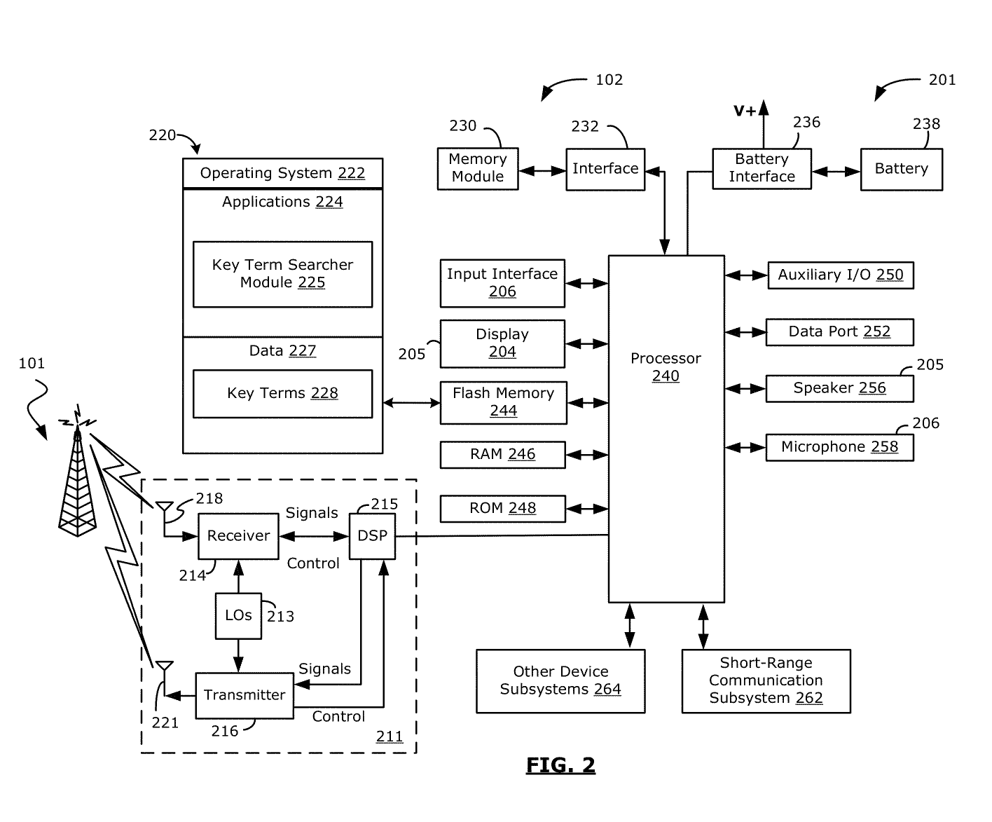

An overview having been provided, reference will now be made to FIG. 2, which illustrates an example first electronic device 102. In the illustrated example embodiment, the first electronic device 102 is a mobile communication device 201. In at least some example embodiments, the mobile communication device 201 is a two-way communication device having data and possibly voice communication capabilities, and the capability to communicate with other computer systems; for example, via the internet. Depending on the functionality provided by the first electronic device 102, in various example embodiments the first electronic device 102 may be a multi-mode communication device configured for both data and voice communication, a mobile telephone such as a smartphone, a tablet computer such as a slate computer, a wearable computer such as a watch, a PDA (personal digital assistant), a computer system such as a desktop, netbook, laptop, or notebook computer system.

A smartphone is a mobile phone which offers more advance computing capability than a basic non-smart cellular phone. For example, a smartphone may have the ability to run third party applications which are stored on the smartphone.

A tablet computer (which may also be referred to as a tablet) is an electronic device which is generally larger than a mobile phone (such as a smartphone) or personal digital assistant. Many mobile phones or personal digital assistants are designed to be pocket sized. That is, mobile phones or personal digital assistants are generally small enough to be carried by a person easily, often in a shirt or pant pocket while tablet computers are larger and may not fit within pant pockets. For example, many tablet computers have a height which is seven inches (7″) or more. In some example embodiments, the tablet computer may be a slate computer. A slate computer is a tablet computer which does not include a dedicated keyboard. A slate computer may allow for text input through the use of a virtual keyboard or an external keyboard which connects to the slate computer via a wired or wireless connection.

In other example embodiments, the first electronic device 102 may be of a type not specifically listed above.

The mobile communication device 201 of FIG. 2 includes a housing (not shown) which houses components of the mobile communication device 201. Internal components of the mobile communication device 201 may be constructed on a printed circuit board (PCB). The mobile communication device 201 includes a controller including at least one processor 240 (such as a microprocessor) which controls the overall operation of the mobile communication device 201. The processor 240 interacts with device subsystems such as a wireless communication subsystem 211 for exchanging radio frequency signals with a wireless network 101 to perform communication functions. The processor 240 interacts with additional device subsystems including one or more input interfaces 206 (such as a keyboard, one or more control buttons, one or more microphones 258, and/or a touch-sensitive overlay associated with a touchscreen display), flash memory 244, random access memory (RAM) 246, read only memory (ROM) 248, auxiliary input/output (I/O) subsystems 250, a data port 252 (which may be a serial data port, such as a Universal Serial Bus (USB) data port), one or more output interfaces 205 (such as a display 204 (which may be a liquid crystal display (LCD)), one or more speakers 256, or other output interfaces 205), a short-range communication subsystem 262, and other device subsystems generally designated as 264. Some of the subsystems shown in FIG. 2 perform communication-related functions, whereas other subsystems may provide “resident” or on-device functions.

The mobile communication device 201 may include a touchscreen display in some example embodiments. The touchscreen display may be constructed using a touch-sensitive input surface connected to an electronic controller. The touch-sensitive input surface overlays the display 204 and may be referred to as a touch-sensitive overlay. The touch-sensitive overlay and the electronic controller provide a touch-sensitive input interface 206 and the processor 240 interacts with the touch-sensitive overlay via the electronic controller. That is, the touchscreen display acts as both an input interface 206 and an output interface 205.

The communication subsystem 211 includes a receiver 214, a transmitter 216, and associated components, such as one or more antenna elements 218 and 221, local oscillators (LOs) 213, and a processing module such as a digital signal processor (DSP) 215. The antenna elements 218 and 221 may be embedded or internal to the mobile communication device 201 and a single antenna may be shared by both the receiver 214 and the transmitter 216. The particular design of the wireless communication subsystem 211 depends on the wireless network 101 in which the mobile communication device 201 is intended to operate.

The mobile communication device 201 may communicate with any one of a plurality of fixed transceiver base stations of the wireless network 101 within its geographic coverage area. The mobile communication device 201 may send and receive communication signals over the wireless network 101 after the required network registration or activation procedures have been completed. Signals received by the antenna 218 through the wireless network 101 are input to the receiver 214, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 215. In a similar manner, signals to be transmitted are processed, including modulation and encoding, for example, by the DSP 215. These DSP-processed signals are input to the transmitter 216 for digital-to-analog (D/A) conversion, frequency up conversion, filtering, amplification, and transmission to the wireless network 101 via the antenna 221. The DSP 215 not only processes communication signals, but may also provide for receiver and transmitter control. For example, the gains applied to communication signals in the receiver 214 and the transmitter 216 may be adaptively controlled through automatic gain control algorithms implemented in the DSP 215.

In some example embodiments, the auxiliary input/output (I/O) subsystems 250 may include an external communication link or interface, for example, an Ethernet connection. The mobile communication device 201 may include other wireless communication interfaces for communicating with other types of wireless networks; for example, a wireless network such as an orthogonal frequency division multiplexed (OFDM) network. The auxiliary I/O subsystems 250 may include a pointing or navigational tool (input device) such as a clickable trackball or scroll wheel or thumbwheel, or a vibrator for providing vibratory notifications in response to various events on the mobile communication device 201 such as receipt of an electronic message or incoming phone call, or for other purposes such as haptic feedback (i.e. touch feedback).

In some example embodiments, the mobile communication device 201 also includes a removable memory module 230 (typically including flash memory) and a memory module interface 232. Network access may be associated with a subscriber or user of the mobile communication device 201 via the memory module 230, which may be a Subscriber Identity Module (SIM) card for use in a GSM network or other type of memory module for use in the relevant wireless network type. The memory module 230 may be inserted in or connected to the memory module interface 232 of the mobile communication device 201.

The mobile communication device 201 may store data 227 in an erasable persistent memory, which in one example embodiment is the flash memory 244. In various example embodiments, the data 227 may include service data having information required by the mobile communication device 201 to establish and maintain communication with the wireless network 101. The data 227 may also include user application data such as email messages, address book and contact information, calendar and schedule information, notepad documents, image files, and other commonly stored user information stored on the mobile communication device 201 by its user, and other data. The data 227 may also include one or more key terms 228.

The key terms 228 may be words and/or phrases which may be used by the first electronic device 102 to determine if a complementary application should be initiated to complement a communication. In some example embodiments, the key terms 228 may be location-based, time-based, image-based and/or contact-based key terms. By way of example, a location-based key term may include one or more of the words “where”, “address”, “location”, etc., a time-based key term may include one or more of the words “when”, “time”, “meet”, “schedule”, etc., an image-based key term may include the words “picture”, “image”, “photo”, “pic”, etc., and a contact-based key term may include a name of a contact (e.g. a business name or a personal name) in a contact record stored on the first electronic device A key term 228 may have an application associated therewith so that, when a key term 226 is identified in text, the application associated with that key term may be initiated. The key terms 228 may also include associated synonyms and conjugations of words.

The data 227 stored in the persistent memory (e.g. flash memory 244) of the mobile communication device 201 may be organized, at least partially, into a number of databases or data stores each containing data items of the same data type or associated with the same application. For example, email messages, contact records, and task items may be stored in individual databases within the mobile communication device 201 memory. In at least some example embodiments, each of the key terms 228 may be stored in individual databases or data stores.

The data port 252 may be used for synchronization with a user's host computer system. The data port 252 enables a user to set preferences through an external device or software application and extends the capabilities of the mobile communication device 201 by providing for information or software downloads to the mobile communication device 201 other than through the wireless network 101. The alternate download path may for example, be used to load an encryption key onto the mobile communication device 201 through a direct, reliable and trusted connection to thereby provide secure device communication.

In some example embodiments, the mobile communication device 201 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their mobile communication device 201 to the host computer system via a USB cable or Bluetooth® connection, traffic that was destined for the wireless network 101 is automatically routed to the mobile communication device 201 using the USB cable or Bluetooth® connection. Similarly, any traffic destined for the wireless network 101 is automatically sent over the USB cable Bluetooth® connection to the host computer for processing.

The mobile communication device 201 also includes a battery 238 as a power source, which is typically one or more rechargeable batteries that may be charged, for example, through charging circuitry coupled to a battery interface 236 such as the serial data port 252. The battery 238 provides electrical power to at least some of the electrical circuitry in the mobile communication device 201, and the battery interface 236 provides a mechanical and electrical connection for the battery 238. The battery interface 236 is coupled to a regulator (not shown) which provides power V+ to the circuitry of the mobile communication device 201.

The short-range communication subsystem 262 is an additional optional component which provides for communication between the mobile communication device 201 and different systems or devices, which need not necessarily be similar devices. For example, the short-range communication subsystem 262 may include an infrared device and associated circuits and components, or a wireless bus protocol compliant communication mechanism such as a Bluetooth® communication module to provide for communication with similarly-enabled systems and devices.

A predetermined set of applications that control basic device operations, including data and possibly voice communication applications may be installed on the mobile communication device 201 during or after manufacture. Additional applications and/or upgrades to an operating system 222 or software applications 224 may also be loaded onto the mobile communication device 201 through the wireless network 101, the auxiliary I/O subsystem 250, the data port 252, the short-range communication subsystem 262, or other suitable device subsystems 264. The downloaded programs or code modules may be permanently installed; for example, written into the program memory (e.g. the flash memory 244), or written into and executed from the RAM 246 for execution by the processor 240 at runtime.

In some example embodiments, the mobile communication device 201 may provide two principal modes of communication: a data communication mode and a voice communication mode. In the data communication mode, a received data signal such as a text message, an email message, or webpage download will be processed by the communication subsystem 211 and input to the processor 240 for further processing. For example, a downloaded webpage may be further processed by a web browser or an email message may be processed by the email messaging application and output to the display 204. A user of the mobile communication device 201 may also compose data items, such as email messages; for example, using an input interface 206 in conjunction with the display 204. These composed items may be transmitted through the communication subsystem 211 over the wireless network 101.

In the voice communication mode, the mobile communication device 201 provides telephony functions and may operate as a typical cellular phone. The overall operation is similar to the data communication mode, except that the received signals would be output to the speaker 256 and signals for transmission would be generated by a transducer such as the microphone 258. The telephony functions are provided by a combination of software/firmware (i.e., a voice communication module) and hardware (i.e., the microphone 258, the speaker 256 and input devices). Alternative voice or audio I/O subsystems, such as a voice message recording subsystem, may also be implemented on the mobile communication device 201. Although voice or audio signal output may be accomplished primarily through the speaker 256, the display 204 may also be used to provide an indication of the identity of a calling party, duration of a voice call, or other voice call related information.

The processor 240 operates under stored program control and executes software modules 220 stored in memory such as persistent memory; for example, in the flash memory 244. As illustrated in FIG. 2, the software modules 220 may include operating system software 222 and one or more additional applications 224 or modules such as, for example, a key term searcher module 225. In the example embodiment of FIG. 2, the key term searcher module 225 is illustrated as being implemented as a separate stand-alone application 224, but in other example embodiments, this module could be implemented as part of the operating system 222 or another application 224.

The mobile communication device 201 may include a range of additional software applications 224, including, for example, a notepad application, voice communication (i.e. telephony) application, mapping application, a media player application, or any combination thereof. Each of the software applications 224 may include layout information defining the placement of particular fields and graphic elements (e.g. text fields, input fields, icons, etc.) in the user interface (i.e. the display 204) according to the application.

The software modules 220 or parts thereof may be temporarily loaded into volatile memory such as the RAM 246. The RAM 246 is used for storing runtime data variables and other types of data or information. Although specific functions are described for various types of memory, this is merely one example, and a different assignment of functions to types of memory could also be used.

The operating system 222 is software that manages electronic device 201 components (such as the display 204, input interface 206, communication subsystem 211, etc.) and provides a platform for software applications 224. The operating system 222 may act as an intermediary between the electronic device 201 components and the software applications 224. For example, the operating system 222 may recognize data that is being input from a navigational input device and route the inputted data to be executed by a software application 224. The operating system 222 may be Microsoft Windows OS™, BlackBerry OS™, iOS™, Linux™, UNIX™, Android™ or any other operating system 222 having the necessary capabilities for implementing the functions described herein.

The operating system 222 may be configured to establish a connection between the first electronic device 102 and the second electronic device 104. That is, the operating system 222 is capable of establishing a form of connection between devices so that they can communicate with another. In at least some example embodiments, the connection may be established wirelessly or non-wirelessly. In at least some example embodiments, the connection may be established by a pairing process which creates a trusted relationship between the first electronic device 102 and the second electronic device 104. In at least some example embodiments, during the pairing process, the operating system 222 may create and store trusted relationship information that may be retrieved and used to automatically maintain connections between the first electronic device 102 and the second electronic device 104 without having to re-start the pairing process during each connection session.

The key term searcher module 225 may be configured to initiate an application on a second electronic device 104 (FIG. 1). For example, in at least some example embodiments, after a connection between the first electronic device 102 and a second electronic device 104 is established, the key term searcher module 225 may determine if a communication having textual information received at the first electronic device includes at least one key term. In at least some example embodiments, when determining if the textual information includes at least one key term, the key term searcher module 225 may retrieve the key terms 228 stored in the memory of the electronic device 102 and compare the textual information to one or more of the retrieved key terms 228. If the key term searcher module 225 determines that the textual information includes at least one key term (for example, a key term from the retrieved key terms 228), the key term searcher module 225 may initiate an application on the second electronic device 104 based on the located key term(s).

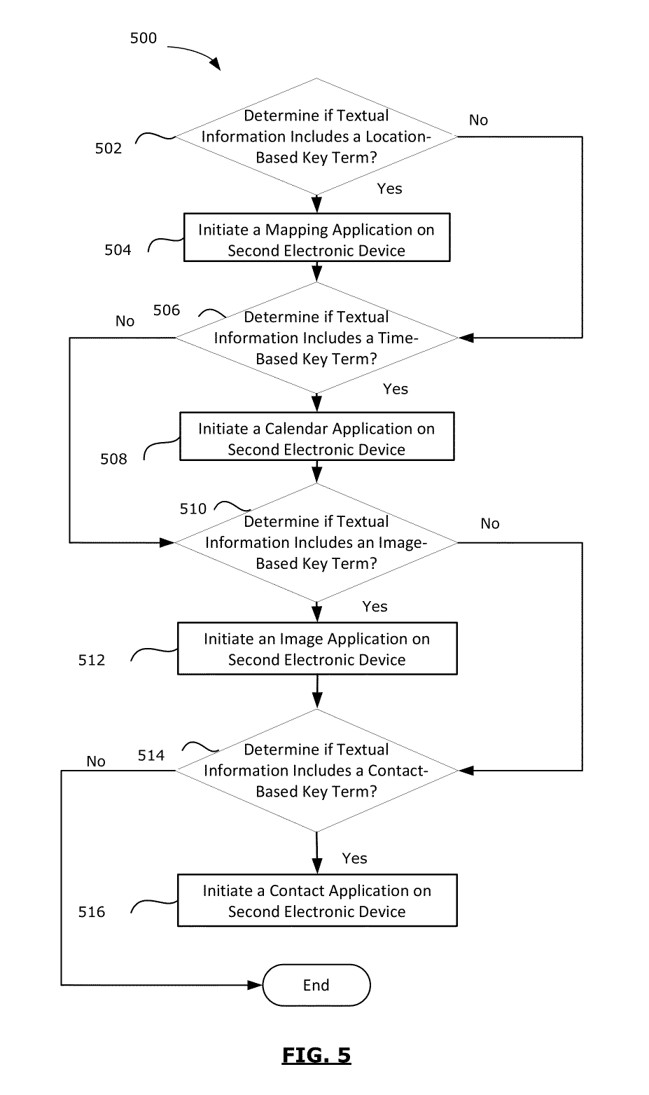

Specific functions and features of the operating system 222 and the key term searcher module 225 will be discussed in greater detail below with reference to FIGS. 4 and 5.

In at least some example embodiments, the operating system 222 may perform some or all of the functions of the key term searcher module 225. In other example embodiments, the functions or a portion of the functions of the operating system 222 and/or the key term searcher module 225 may be performed by one or more other applications. For example, in at least some example embodiments, the pairing process or initiation function may be performed by other applications.

Further, while the key term searcher module 225 has been illustrated as a stand-alone application, in other example embodiments, the key term searcher module 225 may be implemented as part of the operating system 222 or another application 224. Furthermore, in at least some example embodiments, the functions of the key term searcher module 225 may be provided by a plurality of software modules. In at least some example embodiments, these software modules may be divided among multiple applications.

### Example Second Electronic Device

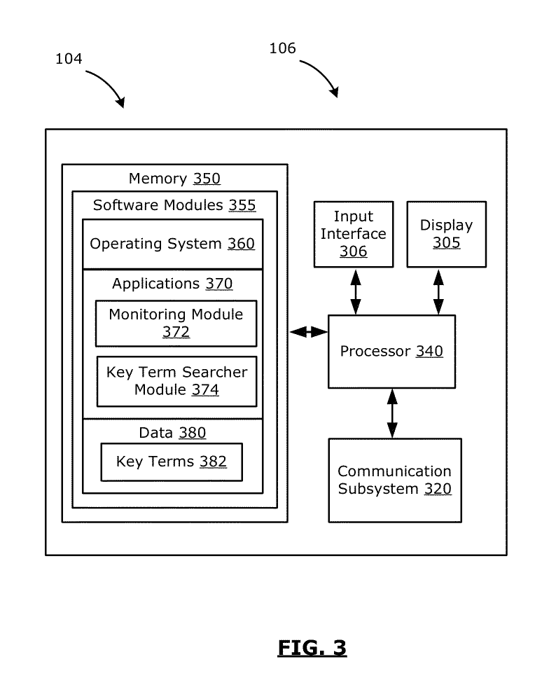

Reference is now made to FIG. 3, which shows in block diagram form an example second electronic device 104 or an example third electronic device 106. The second electronic device 104 is configured to receive communications from the first electronic device 102 (of FIGS. 1 and 2) to initiate a complementary application. The second electronic device 104 may run and display the complementary application on a display 305 associated with the second electronic device 104. In at least some example embodiments, the second electronic device 104, may be configured to initiate an application to complement the first electronic device 102 by, for example, monitoring the first electronic device 102 for communications and determining if textual information within a communication received at the first electronic device 102 includes at least one key term.

The second electronic device 104 may be of a variety of different types. For example, in some example embodiments, the second electronic device 104 is a tablet computer. In other example embodiments, the second electronic device 104 is a notebook, laptop, or netbook style computer. In yet further example embodiments, the second electronic device 104 is a mobile communication device 201 (of FIG. 2), such as a cellular phone, smartphone or other style mobile communication device. For example, in some example embodiments, the second electronic device 104 may be a mobile communication device 201 of the type described above with reference to FIG. 2. In yet further example embodiments, the second electronic device 104 may be a wearable computer, such as a watch. The second electronic device 104 may be of other types not specifically listed herein.

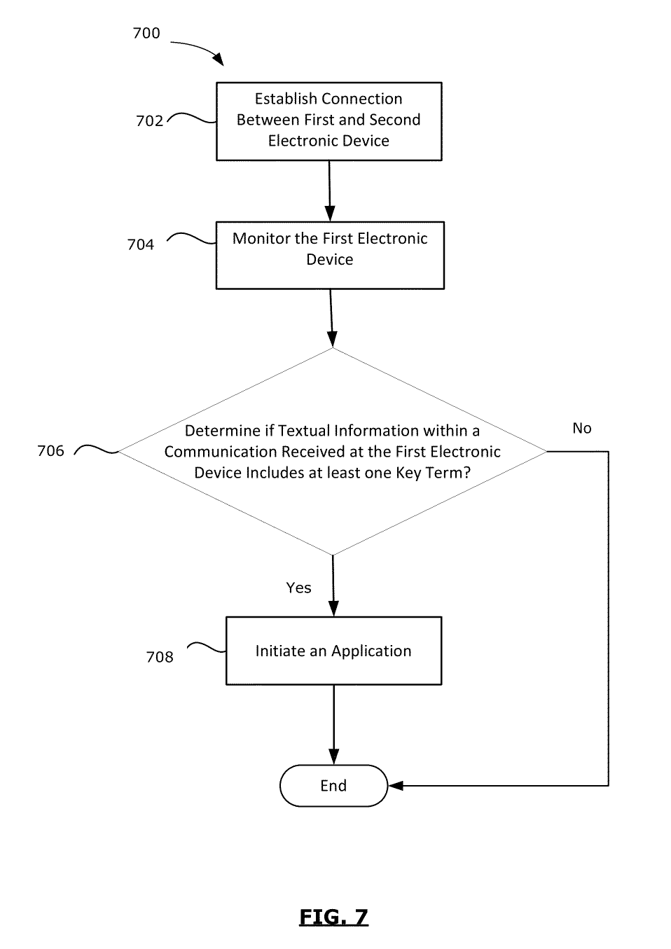

The second electronic device 104 includes a controller, including one or more processors 340 which control the overall operation of the second electronic device 104. The second electronic device 104 may include a memory 350 which is communicatively connected to the processor 340. The memory 350 may be configured to provide data stored in the memory 350 to the processor 340. For example, the memory 350 may include processor readable instructions for causing the processor 340 to perform a method such as, for example, one or more of the methods described below with reference to FIG. 7.

While the memory 350 is illustrated as a single component, it will typically include multiple memory components of various types. For example, the memory 350 may include random access memory (RAM), read only memory (ROM), a hard disk drive (HDD), a solid state drive (SSD), flash memory, or other types of memory. It will be appreciated that each of these various types of memory will be best suited for different purposes and applications.

The processor 340 may operate under stored program control and may execute software modules 355. The software modules 355 may, in at least some example embodiments, include operating system software 360 and one or more additional applications 370 or modules such as, for example, a monitoring module 372 and a key term searcher module 374. The operating system 360 and the key term searcher module 374 may perform similar functions as the operating system 222 (of FIG. 2) and the key term searcher module 225 (of FIG. 2) of the first electronic device 102.

As discussed above, the operating system 360 is software that manages electronic device components and provides a platform for software applications 370. The operating system 360 may act as an intermediary between the electronic device components and the software applications 370. For example, the operating system 360 may recognize data that is being input from a navigational input device and route the inputted data to be executed by a software application 370.

The operating system 360 may be configured to allow the second electronic device 104 to establish a connection with the first electronic device 102. Accordingly, the operating system 360 of the second electronic device 104 may work together with a corresponding operating system 222 (of FIG. 2) of the second electronic device 102. For example, in a pairing process to establish a connection between the first electronic device 102 and the second electronic device 104, the operating systems 222, 360 may work in conjunction, and a user may be required to verify or confirm on either or both the first electronic device 102 and the second electronic device 104 that a trusted relationship should be created between the two electronic devices 102, 104. In at least some example embodiments, during the pairing process, the operating system 360 may create and store trusted relationship information that may be retrieved and used to automatically maintain connections between the first electronic device 102 and the second electronic device 104 without having to re-start the pairing process during each connection session.

The software modules 355, may, in at least some example embodiments, include a monitoring module 372. The monitoring module 372 may, for example, be configured to monitor the first electronic device 102 for a communication after a connection is established between the first electronic device 102 and the second electronic device 104. That is, the monitoring module 372 may have permission to monitor the first electronic device 102 for communications, such as email messages or instant messages, received at the first electronic device 102. The monitoring may be performed while there is a connection between the first electronic device 102 and the second electronic device 104. The monitoring module 372 will be described in greater detail below with reference to FIG. 7.

The software modules 355 may, in at least some example embodiments, include a key term searcher module 374. The key term searcher module 374 may be configured to initiate an application. For example, in at least some example embodiments, after a connection between the first electronic device 102 and a second electronic device 104 is established, the key term searcher module 225 may determine if a communication having textual information received at the first electronic device includes at least one key term. If the key term searcher module 374 determines that the textual information includes at least one key term, the key term searcher module 374 may initiate an application on the second electronic device 104 based on the located key term to complement the first electronic device 102.

In at least some example embodiments, during the determination process, the key term searcher module 374 may have access to one or more key terms 382 that are compared to text in the received communication. That is, the key term searcher module 374 may determine that a received communication includes at least one key term if text in that communication matches one or more accessed key terms 382. In at least some example embodiments, the key terms 382 may be stored in the memory 350 (for example, a data area 380 of the memory 350) of the second electronic device 104. As discussed above, the key terms may be words and/or phrases, and may define location-based, time-based and image-based words and phrases. Functions and features of the key term searcher module 374 will be discussed in greater detail below with reference to FIG. 7.

The memory 350 of the second electronic device 102 may also store various applications 370 that may be retrieved and accessed to initiate the complementary application on the second electronic device 102. The applications 370 stored and initiated may include mapping applications, calendar applications, notebook applications, word processor applications, spreadsheet applications, image editing applications, etc. The memory 350 may also store other data not specifically referred to herein.

The second electronic device 104 may include one or more input interfaces 306 (such as a keyboard, one or more control buttons, one or more microphones, and/or a touch-sensitive overlay associated with a touchscreen display). The input interfaces 306 are configured to input instructions and commands to the second electronic device 104 to perform specific tasks and functions. For example, a user may input instructions to establish a connection between the first electronic device 102 and the second electronic device 104. The second electronic device 104 may also include a display 305. The display 305 may be configured to display content such as a graphical user interface of an initiated application to a user of the second electronic device 104. The input interfaces 306 and the display 305 may be controlled by the processor 340.

The second electronic device 104 may include one or more communication subsystems 320 for communicating with other systems, servers, or electronic devices. For example, a communication subsystem 320 may be provided on the second electronic device 104 to allow the second electronic device 104 to communicate with the first electronic device 102. As described above with reference to FIG. 1, in some example embodiments, the second electronic device 104 may communicate with the first electronic device 102 via a network 124 (of FIG. 1). In other example embodiments, the communication subsystem 320 may allow the second electronic device 104 to communicate more directly with the first electronic device 102. That is, in at least some example embodiments, the first electronic device 102 and the second electronic device 104 may communicate with one another through a direct connection such as a direct wireless connection. In at least some example embodiments, the communication subsystem 320 may be a wireless communication interface such as Wi-Fi or Bluetooth or may be a communication subsystem 320 which is configured to communicate via wired communications, such as Ethernet communications. The communication subsystem 320 may take other forms apart from those specifically listed herein.

The software modules 355 may be logically or physically organized in a manner that is different than the manner illustrated in FIG. 3. By way of example, the features described herein with reference to the operating system 360, the monitoring module 372, and/or the key term searcher module 374 may be divided or combined into a greater number or lesser number of software modules. For example, functions which are described with reference to a single software application or module may be provided by a plurality of software applications or modules. Similarly, functions which are described with reference to multiple software applications or modules may be provided by a single software application or module. Similarly, in at least some example embodiments, the functions of two or more of these modules may be combined into a single module. Thus, the software modules 355 described with reference to FIG. 3 represent one possible assignment of features to software modules. However, such features may be organized in other ways in other example embodiments. Furthermore, the second electronic device 104 may include other software applications or modules which provide features which are not specifically discussed herein.

### Example Method of Initiating an Application

Reference will now be made to FIG. 4 which illustrates an example method 400 of initiating an application on a second electronic device 104. The method 400 includes features which may be provided by a first electronic device 102, such as the mobile communication device 201 of FIG. 2. More particularly, one or more applications or modules associated with the first electronic device 102, such as the operating system software 222 and the key term searcher module 225 (of FIG. 2), may contain processor readable instructions for causing a processor associated with the first electronic device 102 to perform the method 400 of FIG. 4. That is, in at least some example embodiments, the first electronic device 102 is configured to perform the method 400 of FIG. 4.

In at least some example embodiments, one or more of the features of the method 400 of FIG. 4 may be provided, in whole or in part, by another system, software application, module, or device apart from those specifically listed above. For example, in at least some example embodiments, one or more of the features of the method 400 may be performed, at least in part, by the second electronic device 104 (of FIG. 3).

The method 400 includes, at 402, establishing a connection between the first electronic device 102 and the second electronic device 104. That is, a communication link is established between the first electronic device 102 and the second electronic device 104 to enable them to communicate with one another. In at least some example embodiments, the connection may be established wirelessly using communication subsystems associated with each of the electronic devices 102, 104. In at least some example embodiments, the connection may be a wired connection between the electronic devices 102, 104 using auxiliary I/O subsystems associated with each of the electronic devices (for example, via a wired Universal Serial Bus (USB) connection).

In at least some example embodiments, the first electronic device 102 may wirelessly connect to the second electronic device 104 via a network 124 (as illustrated in FIG. 1). The network 124 may include a private network, and/or a public network, such as the Internet. For example, in at least some example embodiments, the first electronic device 102 and/or the second electronic device 104 are configured for Wi-Fi communications with respective network gateways.

In at least some example embodiments, the first electronic device 102 may wirelessly connect to the second electronic device 104 via a more direct connection without utilizing the network 124. For example, in at least some example embodiments, the first electronic device 102 may connect directly to the second electronic device 104 via a Wi-Fi connection. Similarly, in at least some example embodiments, the first electronic device 102 may connect to the second electronic device 104 via a Bluetooth™ connection. Similarly, in at least some example embodiments, the first electronic device 102 may connect to the second electronic device 104 via a near field communication (NFC) connection. Accordingly, in at least some example embodiments, the first electronic device 102 may be configured to communicate with the second electronic device 104 via other short range communication technology or protocols. That is, a short range wireless connection may be established between the first electronic device 102 and the second electronic device 104.

In at least some example embodiments, in order to connect, the electronic devices 102, 104 may undergo a pairing process. The pairing process creates a trusted relationship between the first electronic device 102 and the second electronic device 104 so that they can perform more advanced communications with one another. That is, the pairing process provides a higher level of security for controlling the connection and communication between the electronic devices 102, 104. For example, in at least some example embodiments, the first electronic device 102 must be paired with the second electronic device 104 in order to initiate an application on the second electronic device 104.

The pairing process may be triggered by a specific request to pair the first electronic device 102 with the second electronic device 104. For example, a user may input an instruction in either or both the first electronic device 102 and the second electronic device 104 in order to pair the electronic devices 102, 104. In at least some example embodiments, authentication may be required in order to pair the electronic devices 102, 104. For example, the first electronic device 102 and/or the second electronic device 104 may cause a display associated with that electronic device 102, 104 to display a pass code or password. In order to complete the pairing process, input of that pass code or password may be required on one or both of the first electronic device 102 and the second electronic device 104.

In at least some example embodiments, during the pairing process, the second electronic device 104 may create trusted relationship information which may be stored in memory 350 of the second electronic device 104. The trusted relationship information may identify the first electronic device 102 and may be used to allow the second electronic device 104 to remember that the first electronic device 102 is trusted by the second electronic device 104. That is, the trusted relationship information may be used by the second electronic device 104 so that the second electronic device 104 is subsequently aware that a trusted relationship exists with the first electronic device 102. The storage of the trusted relationship information 375 may, in at least some example embodiments, allow the electronic devices 102, 104 to subsequently connect to one another. For example, in some example embodiments, after the trusted relationship is established, when the electronic devices 102, 104 are within range to communicate over a short range connection, such as a Bluetooth connection, the devices can automatically connect to one another to allow these electronic devices 102, 104 to communicate with one another. That is, once a trusted relationship is established between the first electronic device 102 and the second electronic device 104, the saved trusted relationship information allow these electronic devices 102, 104 to be automatically connected to one another at some time in the future.

At 404, the first electronic device 102 receives a communication that includes textual information. That is, the received communication includes at least some form of text characters. In at least some example embodiments, the communication may be received via the communication subsystems associated with the first electronic device 102. For example, in at least some example embodiments, the communication may be an email message and/or an instant message. The email message and/or instant message may be received from the second electronic device 104, the third electronic device 106 and/or any other devices. In at least some example embodiments, the received communication may include an email message and/or an instant message having an attachment (such as a word processor file) that includes textual information. The received communication may be in other forms not specifically described herein.

In at least some example embodiments, the first electronic device 102 device may receive the communication from the memory (for example, the flash memory 244). For example, in at least some example embodiments, the first electronic device 102 may retrieve the communication from the data area 227 of memory. That is, the communication which is obtained at 404 may be a communication which was previously received and stored in memory of the first electronic device 201.

In other example embodiments, the communication may be received from an input interface 206 associated with the first electronic device 102. For example, the communication may be input to the first electronic device 102 using a touchscreen or a physical keyboard associated with the electronic device 201. For example, in at least some example embodiments, the communication may be input in a word processing application to include textual information.

After receiving the communication that includes textual information, the first electronic device 102, at 406, determines if the textual information includes at least one key term. In order to determine if the textual information include at least one key term, in at least some example embodiments, the first electronic device 102 searches the textual information for at least one key term. For example, the first electronic device 102 may retrieve one or more key terms 228 stored in the memory of the first electronic device 102, and searches the textual information to determine if the textual information includes the one or more retrieved key terms 228.

In at least some example embodiments, the first electronic device 102 may parse the textual information for at least one key term. Parsing is a process of analyzing a set of data elements for structure in relation to a set of structural rules and producing a set of smaller data elements based on the structural rules. The data elements are matched with appropriate structural rules to break down the data elements. In performing the parsing process, the electronic device 301 may parse the textual information for one or more retrieved key terms 228 stored in the memory of the first electronic device 102.

As discussed above, a key term may be a word and/or a phrase. In at least some example embodiments, the key term may define a characteristic such as a location, time, image, etc. That is, the textual information may be searched or parsed for key terms that define specific characteristics. For example, a location-based key term may include the words “where”, “address”, “location”, etc., a time-based key term may include the words “when”, “time”, “meet”, “schedule”, etc., an image-based key term may include the words “picture”, “image”, “photo”, “pic” etc., and a contact-based key term may include a name of a contact (e.g. a business name or a personal name) in a contact record stored on the first electronic device. That is, one or more of these key terms may be stored and retrieved from the memory of the first electronic device 102. Accordingly, in at least some example embodiments, the first electronic device 102 may search and/or parse the textual information in a received communication for one or more of these words.

If after searching and/or parsing, no key term is found in the textual information, the method 400 may end. If, however, at least one key term is included in the textual information, then at 408, the first electronic device 102 initiates an application on the second electronic device 104 based on the at least one key term.

To initiate the application, the first electronic device 102 may send an instruction or a command to the second electronic device 104 to instruct the second electronic device 104 to initiate the application.

In response to receiving the instruction or command, the second electronic device 104 begins operation of the application (e.g. launches the application, or causes the application to be brought into focus). For example, the launched application may display a graphical user interface or another interface on a display associated with the second electronic device 104 to allow a user to interact with the application. In at least some example embodiments, when initiating the application, the second electronic device 104 may retrieve the application from the memory 350. In at least some example embodiments, the second electronic device 104 may retrieve the application from another device, server and/or network. That is, the second electronic device 104 may load the application from the other device, server and/or network on to the second electronic device 104, and launch the application. For example, the second electronic device 104 may use a web browser to load and launch an appropriate web-based application on the second electronic device 104.

In at least some example embodiments, the initiated application is an application that is not available on the first electronic device 102. That is, the application is not loaded on the first electronic device 102 and is not available to a user of the first electronic device 102. Accordingly, by initiating the application on the second electronic device 104, the application will be available to a user of the first electronic device 102.

In at least some example embodiments, the initiation of the application on the second electronic device 104 is performed while the communication is displayed on the first electronic device 102. That is, the application is launched on the second electronic device 104 at the same time as the communication is displayed on the first electronic device 102. Accordingly, a graphical user interface of the application may be displayed on the second electronic device 104 simultaneously as the communication is displayed on the first electronic device 102, complementing a user experience on the first electronic device 102.

The application initiated on the second electronic device 104 may depend on the at least one key term located in the textual information. For example, in at least some example embodiments, if the first electronic device 102 determines that the textual information includes a location-based key term, the application initiated on the second electronic device 104 is a mapping application. That is, the first electronic device 102 may search for a location-based key term in the textual information, and if located, a mapping application is initiated. Similarly, in at least some example embodiments, if the first electronic device 102 determines that the textual information includes a time-based key term, the application initiated on the second electronic device 104 is a calendar application. That is, the first electronic device 102 may search for a time-based key term in the textual information, and if located, a calendar application is initiated. Similarly, in at least some example embodiments, if the first electronic device 102 determines that the textual information includes an image-based key term, the application initiated on the second electronic device 104 is an image application. That is, the first electronic device 102 may search for an image-based key term in the textual information, and if located, an image application is initiated. It will be appreciated that other types of applications may be initiated based on the type of key term determined. Greater details of the different types of applications initiated are provided below with reference to FIG. 5.

In at least some example embodiments, the first electronic device 102 may automatically initiate the application on the second electronic device 104. That is, the first electronic device 102 initiates the application after it is determined that the textual information in a received communication includes at least one key term, without the need for further input from a user. However, in other example embodiments, further user input is required from a user via an input interface 206 associated with the first electronic device 102 in order to initiate the application. For example, after determining that the textual information in a received communication includes at least one key term, a prompt may be presented via an output interface 205 (such as a display 204) associated with the first electronic device 102 to request confirmation to initiate an application on the second electronic device 104 based on the at least one key term. When confirmation is received by a user via an input interface 206 (such as a navigational input device) associated with the first electronic device 102, the application is initiated on the second electronic device 104.

### Example Method of Determining Different Types of Key Terms

As noted above, the first electronic device 102 may initiate applications based on the presence of various types of key terms in a communication. That is, the type of application initiated on the second electronic device 104, depends on the type of key term searched and located. Examples of the different types of key terms searched, and the different types of applications initiated are now described.

Reference will now be made to FIG. 5 which illustrates an example method 500 of determining different types of key terms in textual information of a received communication at a first electronic device 102. The method 500 includes features which may be provided by the first electronic device 102, such as the mobile communication device 201 of FIG. 2. More particularly, one or more applications or modules associated with the first electronic device 102, such as the operating system software 222 and the key term searcher module 225 (of FIG. 2), may contain processor readable instructions for causing a processor associated with the first electronic device 102 to perform the method 500 of FIG. 5. That is, in at least some example embodiments, the first electronic device 102 is configured to perform the method 500 of FIG. 5.

In at least some example embodiments, one or more of the features of the method 500 of FIG. 5 may be provided, in whole or in part, by another system, software application, module, or device apart from those specifically listed above. For example, in at least some example embodiments, one or more of the features of the method 500 may be performed, at least in part, by the second electronic device 104 (of FIG. 3).

In at least some example embodiments, the method 500 may be performed at 406 and 408 of FIG. 4.

The method 500, may include, at 502, determining if textual information in a received communication at the first electronic device 102 includes a location-based key term. For example, the first electronic device 102 may search or parse the textual information for one or more location-based key terms. In at least some example embodiments, the location-based key terms may be stored in the memory of the first electronic device 102. Accordingly, the first electronic device 102 may retrieve the location-based key terms, and search or parse the textual information for the retrieved location-based key terms. A location-based key term defines a location characteristic of the textual information. For example, in at least some example embodiments, the location-based key terms may include the words and phrases “where”, “address”, “location”, “How do I get there”, etc. It will be appreciated that the location-based key terms may include other words and phrases not specifically described herein.

If after searching and/or parsing, a location-based key term is not found in the textual information, then the first electronic device 102 may determine whether the communication includes a key term of another type. For example, 506 may be performed to determine if the textual information includes a time-based key term.

If, however, a location-based key term is included in the textual information, then at 504, the first electronic device 102 initiates a mapping application on the second electronic device 104. The mapping application is, in some embodiments a navigational mapping application which may be used to provide directions to a destination.

To initiate the mapping application the first electronic device 102 may send an instruction or a command to the second electronic device 104. In response, the second electronic device 104 launches the mapping application. For example, the launched mapping application may display an associated graphical user interface or another interface on a display of the second electronic device 104. Accordingly, a user may have access to the launched mapping application on the second electronic device 104 to complement the communication on the first electronic device 102.

Example mapping applications that may be initiated on the second electronic device 104 may include Google Maps™ by Google, Inc., Yahoo Maps™ by Yahoo, Inc., MapQuest™ by America Online, Inc., etc.

At 506, the first electronic device 102 may determine if the textual information includes a time-based key term. The determination may be performed in a similar manner as described above with respect to 502. For example, the first electronic device 102 may search or parse the textual information for one or more time-based key terms. In at least some example embodiments, the time-based key terms may be stored in the memory of the first electronic device 102. Accordingly, the first electronic device 102 may retrieve the time-based key terms, and search or parse the textual information for the retrieved time-based key terms. A time-based key term defines a time characteristic of the textual information. For example, in at least some example embodiments, the time-based key terms may include the words and phrases “when”, “time”, “meet”, “schedule”, “Let's get together”, etc. It will be appreciated that the time-based key terms may include other words and phrases not specifically described herein.

If after searching and/or parsing, a time-based key term is not found in the textual information, then the first electronic device 102 may determine whether the communication includes a key term of another type. For example, 510 may be performed to determine if the textual information includes an image-based key term.

If, however, a time-based key term is included in the textual information, then at 508, the first electronic device 102 initiates a calendar application on the second electronic device 104.

Similar to 504, in initiating the calendar application, at 508, the first electronic device 102 may send an instruction or a command to the second electronic device 104. In response, the second electronic device 104 launches the calendar application. For example, the launched calendar may display an associated graphical user interface or another interface on a display of the second electronic device 104. Accordingly, a user may have access to the launched calendar application on the second electronic device 104 to complement the communication on the first electronic device 102.

Example calendar applications that may be initiated on the second electronic device 104 may include Rainlendar™ by Kimmo Pekkola, Google Calendar™ by Google, Inc., Lightning Calendar™ by Mozilla Corp., Microsoft Outlook™ by Microsoft Corp., iCal™ by Apple, Inc., etc.

At 510, the first electronic device 102 may determine if the textual information includes an image-based key term. The determination may be performed in a similar manner as described above with respect to 502. For example, the first electronic device 102 may search or parse the textual information for one or more image-based key terms. In at least some example embodiments, the image-based key terms may be stored in the memory of the first electronic device 102. Accordingly, the first electronic device 102 may retrieve the image-based key terms, and search or parse the textual information for the retrieved image-based key terms. An image-based key term defines an image characteristic of the textual information. For example, in at least some example embodiments, the image-based key terms may include the words and phrases “picture”, “image”, “photo”, “pic”, “Did you see the pictures”, etc. It will be appreciated that the image-based key terms may include other words and phrases not specifically described herein.

If after searching and/or parsing, an image-based key term is not found in the textual information, then the first electronic device 102 may determine whether the communication includes a key term of another type. For example, 514 may be performed to determine if the textual information includes a contact-based key term. If, however, an image-based key term is included in the textual information, then at 512, the first electronic device 102 initiates an image application on the second electronic device 104.

Similar to 504, in initiating the image application, at 512, the first electronic device 102 may send an instruction or a command to the second electronic device 104. In response, the second electronic device 104 launches the image application. For example, the launched image application may display an associated graphical user interface or another interface on a display of the second electronic device 104. Accordingly, a user may have access to the launched image application on the second electronic device 104 to complement the communication on the first electronic device 102.

The methods and devices described herein may be modified to identify other types of key terms apart from those specifically described above. Similarly, the methods and devices described herein may be modified to initiate other applications apart from those described herein. For example, in some example embodiments, the key terms may be names or other identifiers associated with contact records. Contact records may be records of contact information for contacts associated with a user of the first electronic device 102, the second electronic device 104 or both. In such example embodiments, the first electronic device 102 may determine (at 514) if textual information in a received communication includes a key term associated with a contact record (such as, for example, a name included in the contact record). That is, the first electronic device 102 may determine if the textual information includes a contact-based key term. The determination may be performed in a similar manner to that described above with respect to 502. More specifically, the electronic device may attempt to determine whether a contact is referenced in the received communication. For example, the first electronic device 102 may search or parse the textual information for one or more key terms associated with a contact record. In at least some example embodiments, the contact records may be stored in the memory of the first electronic device 102. In some example embodiments, the contact records may be stored in memory of the second electronic device 104.

If a contact-based key term is not identified in the textual information, then the method 500 may end.

In at least some embodiments, if a contact is referenced within the received communication (e.g. if a key term associated with the contact record for that contact is identified in the body of the communication at 514), then a contact application (such as an address book application), or a communication application (e.g. phone or message (e.g. email, text) application may be initiated on the second electronic device 104 at 516. In at least some example embodiments, the contact record associated with the contact referenced in the received communication may be automatically displayed from within the contact application.

Example image applications that may be initiated on the second electronic device 104 may include Photoshop™ by Adobe, Inc., Instagram™ by Instagram Inc., Flickr™ by Yahoo, Inc., Photobucket™ by Photobucket, Inc., etc.

It will be appreciated that the many of the features of the method 500 may be performed in a different order than that illustrated in FIG. 5. For example, in at least some example embodiments, 506 and/or 510 may be performed prior to 502. Additionally, in at least some example embodiments, the number of different types of determination of key terms may be varied. For example, the number of determinations may be limited to one or to a plurality of determinations.

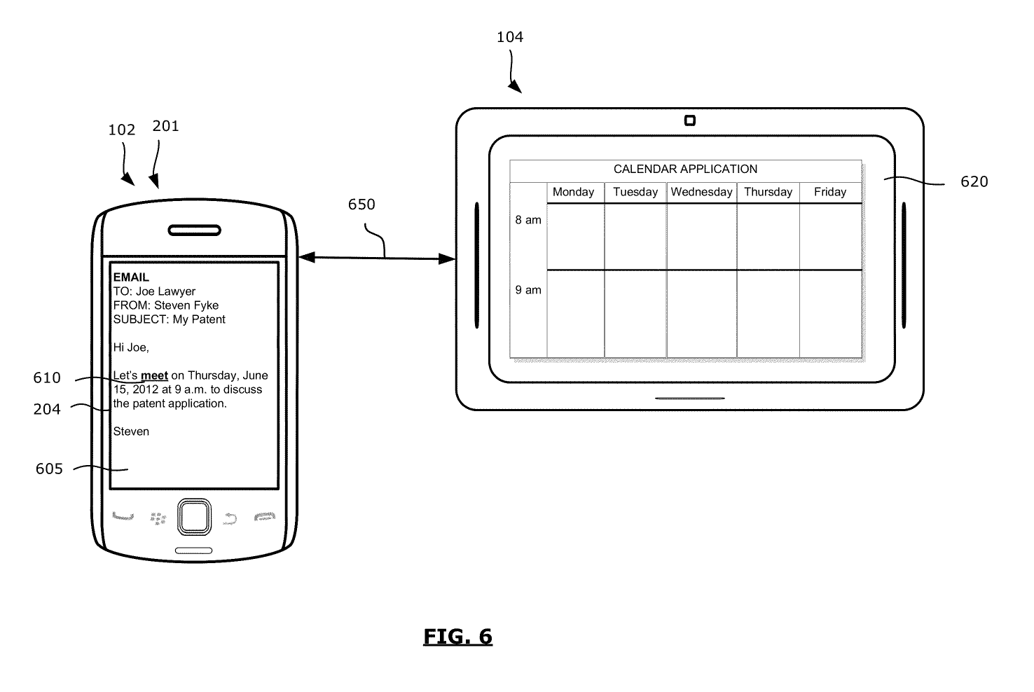

Reference is now made to FIG. 6 which shows an example first electronic device 102 (of FIGS. 1 and 2) (which, in the example illustrated, is a mobile communication device 201 such as a smartphone), and an example second electronic device 104 (of FIGS. 1 and 3) (which, in the example illustrated, is a tablet computer). In the illustrated example, the first electronic device 102 is connected to the second electronic device 104 via a communication link 650 (either wirelessly or non-wirelessly as described above). Accordingly, a connection is established between the first electronic device 102 and the second electronic device 104, allowing the electronic devices 102, 104 to communicate with one another.

The first electronic device 102 has received a communication (for example, an email message 605) that is displayed on a display 204 associated with the first electronic device 102. The communication includes textual information, and a determination of at least one key term in the textual information is made in the same manner as described above with reference to 406 (FIG. 4). More specifically, the textual information is searched for a time-based key term that is located (for example, the word “meet” 610 is located in the email message 605, and is boldened/underlined for illustrative purposes). In determining that the textual information includes a time-based key term, a calendar application 620 is initiated in the second electronic device 104, and displayed on a display associated with second electronic device 104. The calendar application 620 may be initiated by the first electronic device 102, and may be initiated in the same manner as described above with reference to 408 (FIG. 4). Accordingly, a user may have access to the received communication on the first electronic device 102, and the complementary calendar application on the second electronic device 104.

Further to the above example embodiment, the textual information is also searched for a contact-based key term that is located. For example, the words “Joe Lawyer” located in the email message 605 correspond to a contact record stored on the first electronic device, the contact record including the text “Joe Lawyer”. In determining that the textual information additionally includes a contact-based key term, a calendar application 620 is initiated in the second electronic device 104, and displayed on the display associated with second electronic device 104, wherein the calendar application 620 further initiates one of its features, based on the at least one key term: e.g. initiating a calendar event with Joe Lawyer as an attendee of the calendar event. Accordingly, an application initiated on the second electronic device and features of that application initiated on the second electronic device may be based on more than just one key term.

### Further Example Method of Initiating an Application

As noted above, in at least some example embodiments, the second electronic device 104 may perform all or most of the functions for initiating a complementary application, instead of the first electronic device 102. That is, the initiation of the application may be directed by the second electronic device 102.

Referring now to FIG. 7, one such example method 700 of initiating an application on a second electronic device 104 is illustrated. The method 700 includes features which may be provided by a second electronic device 104 (of FIG. 3). More particularly, one or more applications or modules associated with the second electronic device 104, such as the operating system software 360, the monitoring module 372 and the key term searcher module 374, may contain processor readable instructions for causing a processor associated with the second electronic device 104 to perform the method 700 of FIG. 7. That is, in at least some example embodiments, the second electronic device 104 is configured to perform the method 700 of FIG. 7.

In at least some example embodiments, one or more of the features of the method 700 of FIG. 7 may be provided, in whole or in part, by another system, software application, module, or device apart from those specifically listed above. For example, in at least some example embodiments, one or more of the features of the method 700 may be performed, at least in part, by the first electronic device 102 (of FIG. 2).

The method 700 includes, at 702, establishing a connection between the second electronic device 104 and the first electronic device 102. The connection may be established in the same manner as 402 which is described above with reference to FIG. 4.

Additionally, in at least some example embodiments, when establishing the connection, the second electronic device 104 may request access to monitor the first electronic device 102 for a communication. That is, the second electronic device 104 may seek permission to monitor the first electronic device 104 for communications (for example, email messages or instant messages) received at the first electronic device. In response to the request, the second electronic device 104 may receive permission to monitor the first electronic device 102. That is, the first electronic device 102 may grant the second electronic device 104 permission to monitor the first electronic device 102 for communications received at the first electronic device 102. In at least some example embodiments, authentication information (such as a password or passcode) may be required to be input in the second electronic device 104 (and/or the first electronic device 102) to obtain permission to monitor the first electronic device 102. That is, a level of verification may be required to be established in order to allow monitoring.

After establishing the connection, the second electronic device 104, at 704, monitors the first electronic device 102 for a communication that includes textual information (for example, an email message or an instant message). That is, the second electronic device 104 may continuously monitor the first electronic device 104 for any messages and/or instant messages received at the first electronic device 102. The monitoring may be performed so long as there is a connection between the first electronic device 102 and the second electronic device 104. The communication may be received at the first electronic device 102 in the same manner as 404 which is described above with reference to FIG. 4.

In at least some example embodiments, while monitoring, if a communication that includes textual information is received at the first electronic device 102, the second electronic device 104 may be notified, and 706 may be performed.

At 706, the second electronic device 104 may determine if textual information within a communication received at the first electronic device 102 includes at least one key term, and if the textual information includes at least one key term, the second electronic device 104, at 708, may initiate an application. 706 and 708 may be performed in the same manner as 406 and 408 which are described above with reference to FIG. 4.

While the present application is primarily described in terms of methods, a person of ordinary skill in the art will understand that the present application is also directed to various apparatus such as a handheld electronic device and a server. The handheld electronic device and the server includes components for performing at least some of the example aspects and features of the described methods, be it by way of hardware components (such as the memory and/or the processor), software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present application.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

Example embodiments of the present application are not limited to any particular operating system, system architecture, mobile device architecture, server architecture, or computer programming language.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method implemented by a processor of a first electronic device, the method comprising:
establishing a connection between the first electronic device and a second electronic device;
receiving a communication, wherein the communication includes textual information;
determining if the textual information includes at least one key term; and
if the textual information includes the at least one key term, initiating an application on the second electronic device based on the at least one key term.

2. The method of claim 1, wherein the determining comprises determining if the textual information includes a location-based key term, and wherein if the textual information includes the location-based key term, the application initiated on the second electronic device is a mapping application.

3. The method of claim 1, wherein the determining comprises determining if the textual information includes a time-based key term, and wherein if the textual information includes the time-based key term, the application initiated on the second electronic device is a calendar application.

4. The method of claim 1, wherein the determining comprises determining if the textual information includes an image-based key term, and wherein if the textual information includes the image-based key term, the application initiated on the second electronic device is an image application.

5. The method of claim 1, wherein the determining comprises determining if the textual information includes at least one key term associated with a contact record, and wherein if the textual information includes the at least one key term associated with the contact record, the application initiated on the second electronic device is a contact application.

6. The method of claim 5, wherein initiating an application on the second electronic device based on the at least one key term comprises: automatically displaying the contact record associated with the at least one key term on a display of the second electronic device.

7. The method of claim 1, wherein the communication is an email message or an instant message.

8. The method of claim 1, wherein the initiated application is an application that is not available on the first electronic device.

9. The method of claim 1, wherein the at least one key term is defined in a memory of the first electronic device.

10. The method of claim 1, further comprising:
prior to initiating the application, presenting a prompt requesting confirmation to initiate the application on the second electronic device if the textual information includes the at least one key term, and wherein said initiating the application on the second electronic device is performed in response to receiving the confirmation.

11. The method of claim 1, wherein said initiating the application on the second electronic device is performed while the communication is displayed on the first electronic device.

12. A first electronic device comprising:
a communication subsystem for communicating with a second electronic device;
a memory; and
a processor coupled with the memory and the communication subsystem, the processor being configured to:
establish a connection between the first electronic device and a second electronic device;
receive a communication, wherein the communication includes textual information;
determine if the textual information includes at least one key term; and
if the textual information includes the at least one key term, initiate an application on the second electronic device based on the at least one key term.

13. A method implemented by a processor of a second electronic device, the method comprising:
establishing a connection between the second electronic device and a first electronic device;
determining if textual information within a communication received at the first electronic device includes at least one key term; and
if the textual information includes the at least one key term, initiating an application based on the at least one key term.

14. The method of claim 13, further comprising:
after establishing the connection, monitoring the first electronic device for the communication.

15. The method of claim 14, wherein establishing the connection comprises:
requesting access to monitor the first electronic device for the communication; and
in response to the request, receiving permission to monitor the first electronic device.

16. The method of claim 13, wherein the determining comprises determining if the textual information includes a location-based key term, and wherein if the textual information includes the location-based key term, the application initiated is a mapping application.

17. The method of claim 13, wherein the determining comprises determining if the textual information includes a time-based key term, and wherein if the textual information includes the time-based key term, the application initiated is a calendar application.

18. The method of claim 13, wherein the determining comprises determining if the textual information includes an image-based key term, and wherein if the textual information includes the image-based key term, the application initiated is an image application.

19. The method of claim 13, wherein the determining comprises determining if the textual information includes at least one key term associated with a contact record, and wherein if the textual information includes the at least one key term associated with the contact record, the application initiated is a contact application.

20. The method of claim 19, wherein initiating an application based on the at least one key term comprises: automatically displaying the contact record associated with the at least one key term on a display of the second electronic device.

21. (canceled)

22. (canceled)

23. (canceled)

24. (canceled)
